(19) United States
(12) Patent Application Publication
(10) Pub. No.: US 2024/0134438 A1
(43) Pub. Date: Apr. 25, 2024

(54) METHODS AND APPARATUS FOR GRADIENT IMAGE DETECTION TO IMPROVE DISPLAY POWER SAVINGS

(71) Applicant: Intel Corporation, Santa Clara, CA (US)

(72) Inventors: Tamoghna Ghosh, Bangalore (IN); Susanta Bhattacharjee, Bangalore (IN); Mukesh Arora, Bangalore (IN)

(21) Appl. No.: 18/543,824

(22) Filed: Dec. 18, 2023

Related U.S. Application Data
(60) Provisional application No. 63/518,773, filed on Aug. 10, 2023.

(51) Int. Cl. G06F 1/3218

(52) U.S. Cl. CPC G06F 1/3218

(57) ABSTRACT

Systems, apparatus, articles of manufacture, and methods are disclosed for gradient image detection to improve power savings. An example disclosed apparatus includes programmable circuitry to at least one of instantiate or execute the machine readable instructions to identify a region in an image that satisfies a brightness threshold, define a plurality of lines in the image that extend away from the region, and determine the region corresponds to a gradient based on an analysis of pixels along different ones of the plurality of lines.

### RELATED APPLICATION

This patent claims the benefit of U.S. Provisional Patent Application No. 63/518,773, which was filed on Aug. 10, 2023. U.S. Provisional Patent Application No. 63/518,773 is hereby incorporated herein by reference in its entirety. Priority to U.S. Provisional Patent Application No. 63/518,773 is hereby claimed.

### FIELD OF THE DISCLOSURE

This disclosure relates generally to displays and, more particularly, to methods and apparatus for gradient image detection to improve display power savings.

### BACKGROUND

In recent years, display power saving algorithms, techniques, and/or methodologies that perform automatic or adaptive contrast correction of images are used for improving battery life of laptops and other portable devices with display screens. These methodologies modify the pixel intensities in such a way that, even with reduced display backlight the image quality is substantially retained, thereby saving display power without significant degradation to the appearance of images on the display.

### BRIEF DESCRIPTION OF THE DRAWINGS

FIG. 1 is a block diagram of an example environment in which an example gradient image detector circuitry operates to detect a gradient image and improve display power savings.

FIG. 2 is a block diagram of an example implementation of the gradient image detector circuitry of FIG. 1.

FIG. 3 is a flowchart representative of example machine readable instructions and/or example operations that may be executed, instantiated, and/or performed by example programmable circuitry to implement the gradient image detector circuitry of FIG. 2.

FIG. 4 is a flowchart representative of example machine readable instructions and/or example operations that may be executed, instantiated, and/or performed by example programmable circuitry to implement the gradient image detector circuitry of FIG. 2.

FIG. 5 illustrates example synthetic (generated) gradient images with arrows showing the direction of intensity change starting from a bright region and pointing towards darker regions.

FIG. 6A illustrates example synthetic gradient images that resulted in banding artifacts on a display implementing contrast enhancement techniques.

FIG. 6B illustrates example synthetic non-gradient images that did not result in visually noticeable banding artifacts on a display implementing contrast enhancement techniques.

FIG. 7 is an example image that has been blurred to enable gradient image detection.

FIG. 8 illustrates the example image of FIG. 7 following thresholding operation.

FIG. 9 illustrates the example image of FIG. 7 with markers identifying the location and size (e.g., center and radius) of light source(s) in the image of FIG. 7.

FIG. 10A illustrates the example image of FIG. 7 with different potential gradient lines emanating from a first light source in FIG. 7.

FIG. 10B illustrates an example image with a relatively large bright region and associated potential gradient lines generated in accordance with teachings disclosed herein.

FIG. 11 illustrates the example image of FIG. 7 with the lines of FIG. 10 determined to have a sufficiently smooth intensity change to indicate a gradient.

FIG. 12 is a block diagram of an example processing platform including programmable circuitry structured to execute, instantiate, and/or perform the example machine readable instructions and/or perform the example operations of FIGS. 3, and 4 to implement the gradient image detector circuitry of FIG. 2.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, and/or firmware (e.g., corresponding to the example machine readable instructions of FIGS. 3, and 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Example gradient detection techniques are disclosed herein. The examples disclosed herein are very efficient and can be run on a graphics processing unit (GPU), a display system-on-chip (SOC), inside a timing controller (TCON), and/or on any other suitable processor and/or controller. Examples disclosed herein can be implemented in combination with any suitable power saving methodology to take advantage of the power savings of such methodologies while improving user experience by reducing (e.g., minimizing, preventing, eliminating) negative impacts on image quality when gradient images are detected. The teachings disclosed herein can additionally or alternatively be used in connection with other use cases involving changes in pixel intensities of a display (e.g., adaptive brightness of a display in response to changes in ambient light).

Disclosed examples can be used in at least two ways including: (1) directly flagging gradient images in the display pipeline, and (2) automatically annotating (e.g., labelling, classifying) gradient images from a collection (e.g., a database) of images of any suitable number (e.g., several thousand or more). Thereafter, in some examples, these annotated images can be used to train an artificial intelligence (AI) model which can be run on a low power AI accelerator inside a TCON. With either of these approaches the final action taken will be forbidding (e.g., inhibiting, blocking, preventing) application of contrast correction power saving methodologies to gradient images. Disclosed examples can improve the display user experience greatly with contrast enhancement methodologies enabled, which leads to lower power consumption by an associated display.

Methodologies that automatically correct contrast of images to save display power generally do not degrade the appearance of images on the display. However, for certain types of images, these methodologies are unable to preserve quality and create an unsatisfactory user experience. As a result, even if these methodologies are enabled by default on end user platforms, often users or OEMs end up disabling them completely to avoid the poor quality images. Gradient images are one of those categories of images that decrease in quality when contrast enhancement techniques are applied because such methodologies can cause banding artifacts. Although it is relatively easy for a human to identify a gradient image visually, there does not exist any suitable technique for automatic detection of gradient images (e.g., independent of a human). In accordance with teachings disclosed herein, gradient images can be automatically detected, thereby enabling the restraint (e.g., prevention) of power saving methodologies from being applied on such images. As a result, unsatisfactory user experience resulting from degradation in image quality due to gradient images can be avoided without a user having to completely disable the power saving capabilities of an associated computing device. As such, users are more likely to leave the power saving methodologies enabled, thereby leading to a reduction in power consumption.

Among the many possible images and/or user interfaces that may appear on the display of an end user device, gradient images are not that common. Therefore, even if there are no savings in power while displaying such gradient image (e.g., because the power saving methodologies are temporally disabled when such images are displayed), the overall impact on power consumption will be relatively small. That is, most of the benefit of the power saving methodologies will still be realized because such methodologies can still be implemented when gradient images are not detected (e.g., most of the time). Furthermore, power savings may increase in many situations, relative to existing systems, because it is less likely that OEMs and users will disable the use of the power saving methodologies.

There is no existing technique for detecting gradient images automatically. As used herein, gradient images are defined qualitatively as images with smooth variation of pixel intensities across one or more regions of the image. The smoothness of the variation that qualifies an image to be a gradient image is defined by a threshold. Likewise, the total amount of variation for an image to constitute a gradient can also be defined by a threshold. In some examples, the thresholds are set to identify images as gradient images when display power saving methodologies (e.g., methodologies that apply contrast enhancements to images) would result in the display of such images producing banding artifacts visible to an end-user. by contrast, if an image does not produce banding artifacts when displayed with power saving methodologies being applied, such an image is considered a non-gradient image.

Examples disclosed herein perform automatic gradient identification (e.g., automatic gradient detection) by identifying direction(s) (e.g., lines) in the image along which there is relative smooth (e.g., to a given threshold) variation in the intensity of the pixels along the identified direction(s), and determining the range of variation (e.g., relative to a given threshold) that can create artifacts in gradient images. As used herein, the intensity of a pixel refers to the brightness of a pixel as defined by a pixel value ranging from 0 to 255 with a pixel value of 0 being the darkest and a pixel value 255 being the brightest. Examples disclosed herein assume pixel values range from 0-255. However, examples disclosed herein can be suitable adapted (e.g., by adjusting the relevant thresholds discussed herein) for different ranges of minimum and maximum pixel intensity values. Examples disclosed herein can be implemented to efficiently run on any suitable programmable circuitry (e.g., a display SOC, a GPU, or even inside a TCON).

Examples disclosed herein have the potential to significantly improve the acceptance of display power saving methodologies by reducing (e.g., avoiding, eliminating, preventing) image quality degradation. This will lead to more display power saving on computer devices because users will be less likely to completely disable the implementation of display power saving methodologies. Examples disclosed herein can be used directly to detect gradient images and avoid applying any contrast enhancements when such gradient images are to be displayed. Additionally or alternatively, examples disclosed herein can be used to train an artificial intelligence (AI) model that may run in the TCON (or other processor) to classify certain objects being displayed as either gradient images or non-gradient images, such that some special image enhancements can be applied for those objects. Example gradient detection techniques disclosed herein can be used for automatically annotating naturally occurring gradient images to create a training dataset and train the AI model for gradient category along with other categories. This model can be deployed on AI accelerators in a TCON+ and inferences can be run with relatively little power for gradient detection.

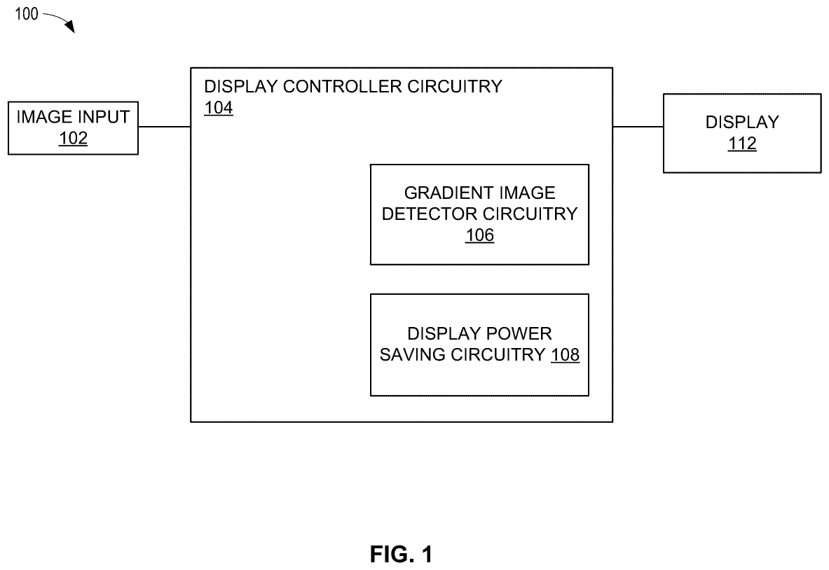

FIG. 1 is a block diagram of an example environment 100 in which an example gradient image detector circuitry 106 operates to detect a gradient image. The illustrated example environment 100 includes an image input 102, a display controller circuitry 104, and a display 112.

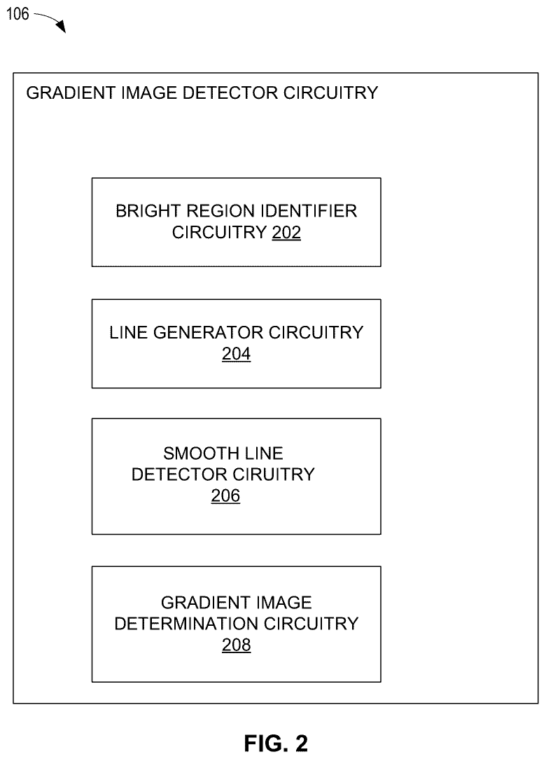

The example display controller circuitry 104 includes the gradient image detector circuitry 106, and a display power saving circuitry 108. The example gradient image detector circuitry 106 analyzes images (e.g., the image input 102) to determine whether the images constitute gradient images (e.g., the images include a region containing a gradient likely to produce banding artifacts if a contrast enhancement display power saving technique were applied to the image). The example display power saving circuitry 108 implements display power saving techniques that reduce power consumption of a display (e.g., by lowering the power consumed by the backlight of the display 112) while substantially retaining image quality. In some examples, such display power saving techniques include contrast enhancement techniques. However, the display power saving circuitry 108 can implement any other suitable type of display power saving technique in addition to or instead of contrast enhancement. In some examples, if the gradient image detector circuitry 106 detects a gradient image to be presented on the display 112, the gradient image detector circuitry 106 causes the display power saving circuitry 108 to temporarily stop the implementation and/or application of the display power saving technique. As a result, the detected gradient image will not result in banding artifacts presented on the display 112. The gradient image detector circuitry 106 is described in more detail below in connection with FIG. 2.

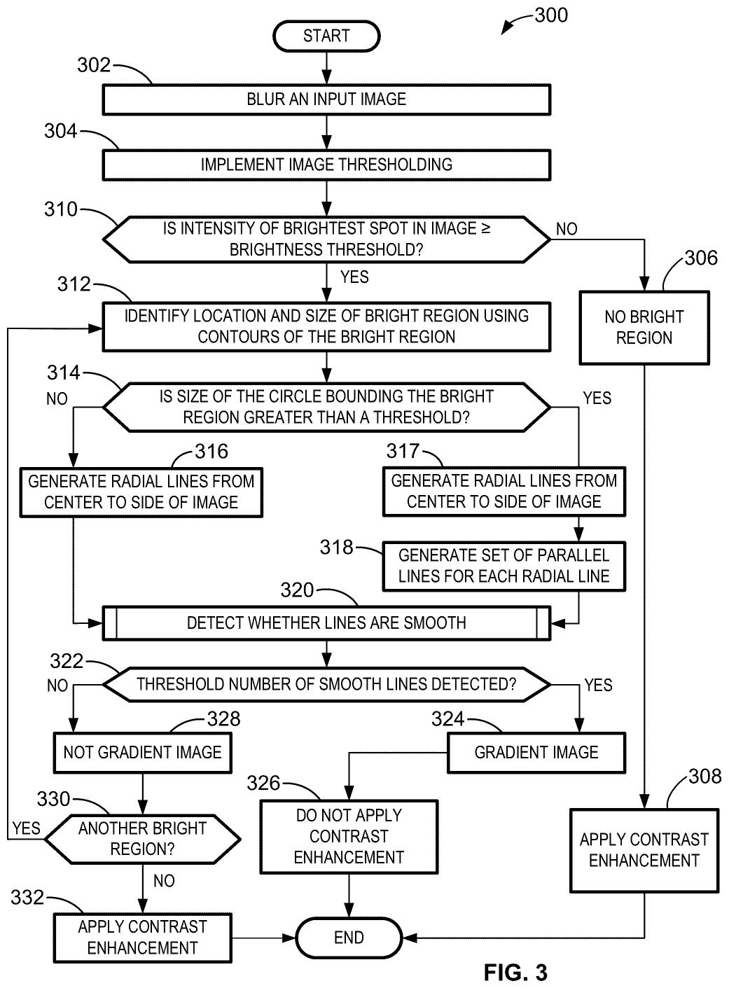

The example display power saving circuitry 108 adjusts a contrast of frames to be presented on the display 112 to reduce power consumption of the display. When a gradient image is detected in ones of the frames, the example display power saving circuitry 108 does not apply contrast enhancement on the corresponding frame(s). If a frame does not contain a detected gradient image (e.g., the frame corresponds to a non-gradient image), the example display power saving circuitry 108 applies contrast enhancement to the frame to reduce power consumption on the display. In some examples, the display power saving circuitry 108 is instantiated by programmable circuitry executing display power saving instructions and/or configured to perform operations such as those represented by the flowchart(s) of FIG. 3.

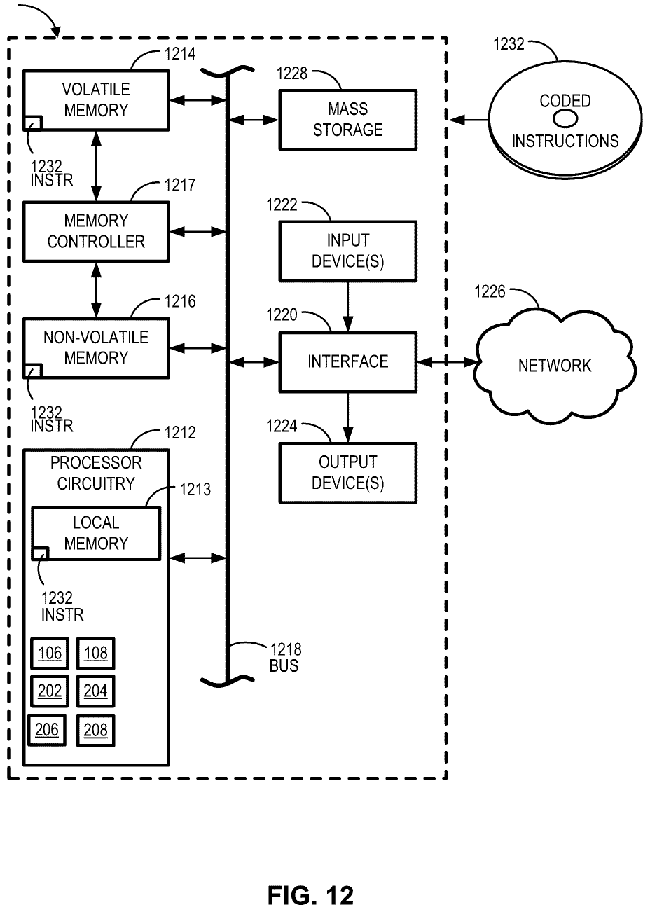

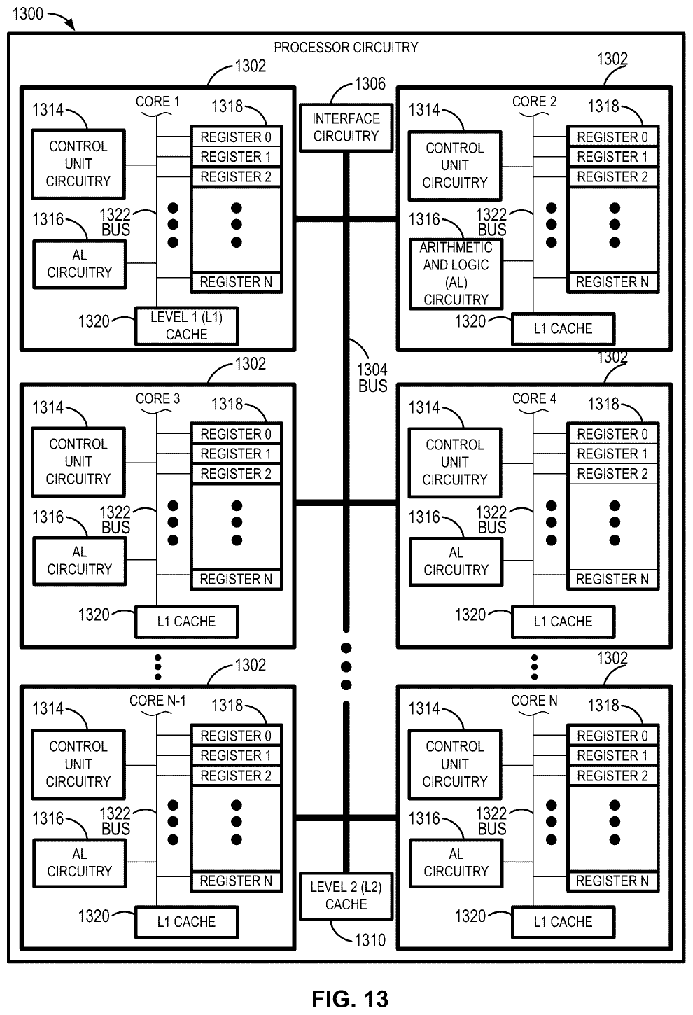

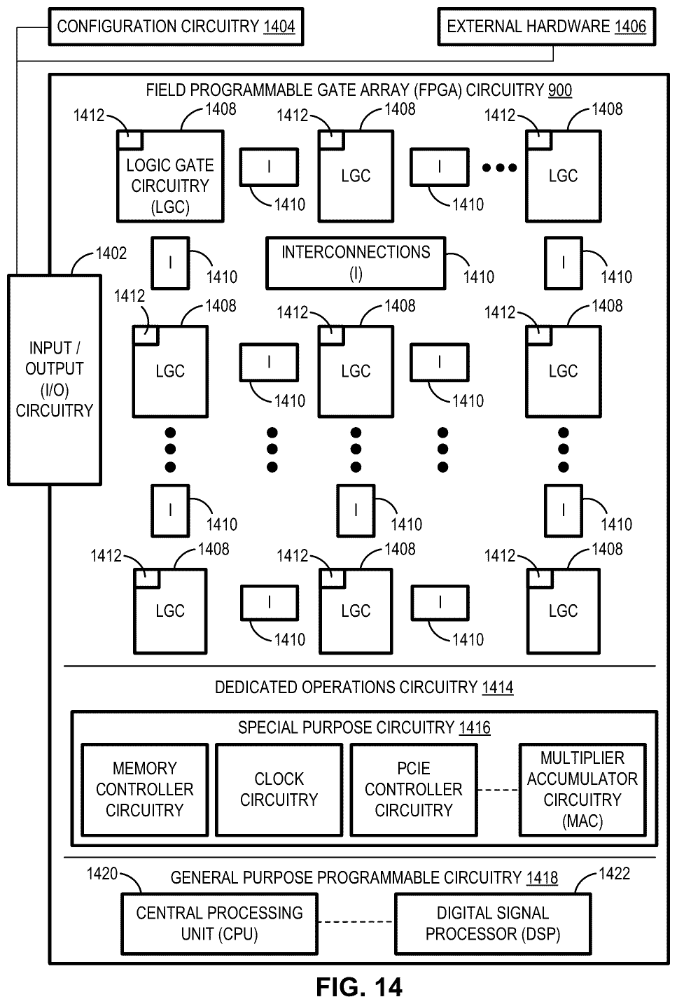

In some examples, the display controller circuitry 104 includes means for adjusting a contrast, which includes a means for stopping the adjustment to the contrast. For example, the means for adjusting a contrast may be implemented by display power saving circuitry 108. In some examples, the display power saving circuitry 108 may be instantiated by programmable circuitry such as the example programmable circuitry 1212 of FIG. 12. For instance, the display power saving circuitry 108 may be instantiated by the example microprocessor 1300 of FIG. 13 executing machine executable instructions such as those implemented by at least blocks 308, 326, and 332 of FIG. 3. In some examples, the display power saving circuitry 108 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the display power saving circuitry 108 may be instantiated by any other combination of hardware, software, and/or firmware. For example, the display power saving circuitry 108 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 2 is a block diagram of an example implementation of the gradient image detector circuitry 106 of FIG. 1 to detect gradient images. The gradient image detector circuitry 106 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the gradient image detector circuitry 106 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example gradient image detector circuitry 106 includes example bright region identifier circuitry 202, example line generator circuitry 204, example smooth line detector circuitry 206, and example gradient image determination circuitry 208.

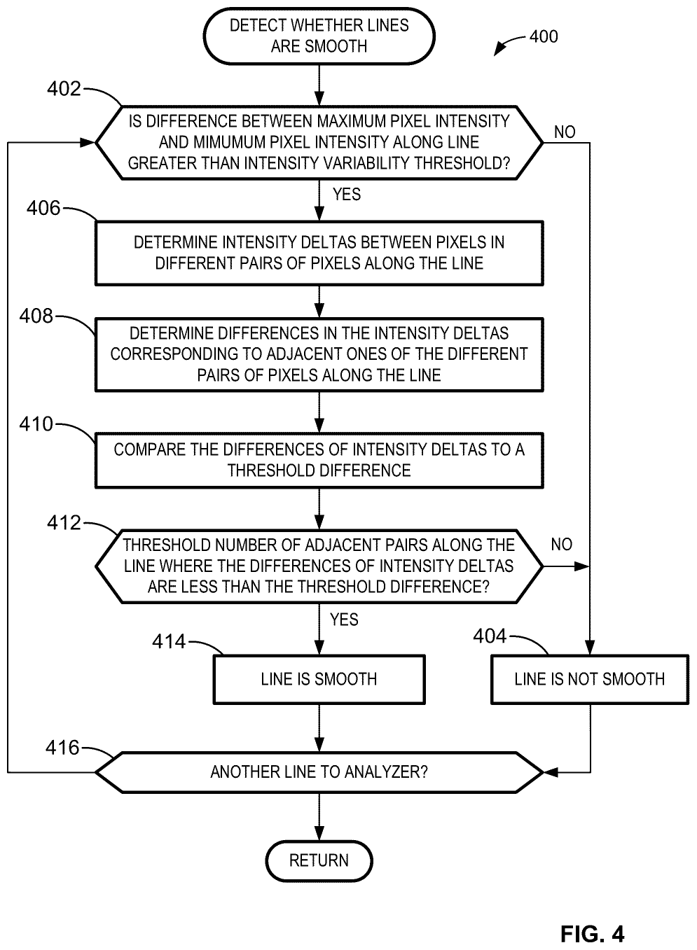

The example gradient image detector circuitry 106 is to identify gradient images. In some examples, the gradient image detector circuitry 106 is instantiated by programmable circuitry executing gradient image detector instructions and/or configured to perform operations such as those represented by the flowchart(s) of FIGS. 3 and 4.

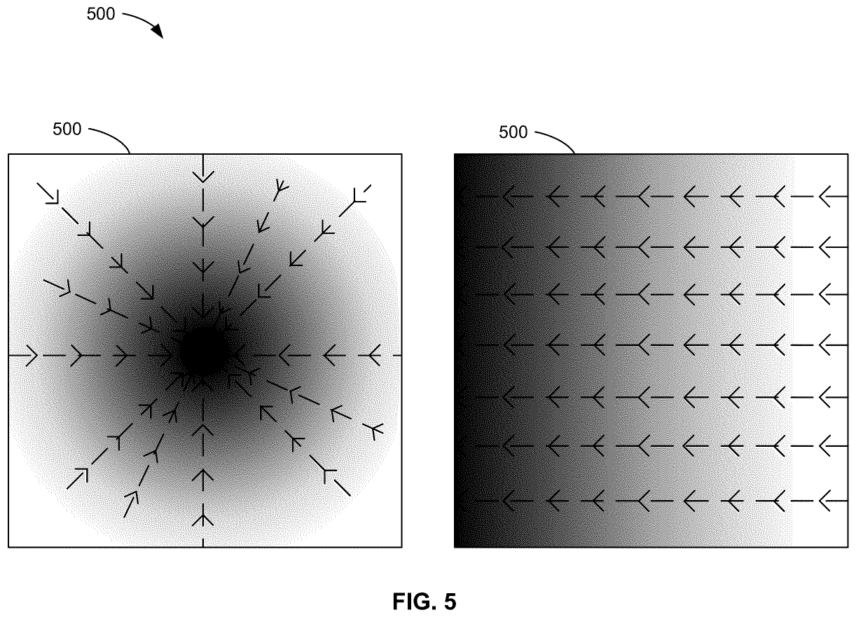

On a general level, a gradient image is an image in which there is smooth variation in pixel intensities in one or more regions of the image or across the entire image. Shown in FIG. 5 are a few examples of synthetic (generated) gradient images with the arrows showing the direction of intensity change starting from the bright region and pointing towards darker regions. More particularly, as used herein, a gradient image is an image that includes a gradient likely to result in banding artifacts visible to an end user when display power saving methodologies are implemented (e.g., methodologies that apply contrast enhancements to images) while the image is being displayed. Such gradients are detected based on the variation of intensity and associated smoothness of the variation satisfying certain threshold(s). By contrast, as used herein, a non-gradient image is an image that is unlikely to produce banding artifacts when displayed with power saving methodologies being applied. That is, while nearly all images include some measure of variation in pixel intensities, the amount of variation and/or the smoothness of such variation may be insufficient (e.g., does not satisfy associated threshold(s)) to constitute a gradient image as defined herein.

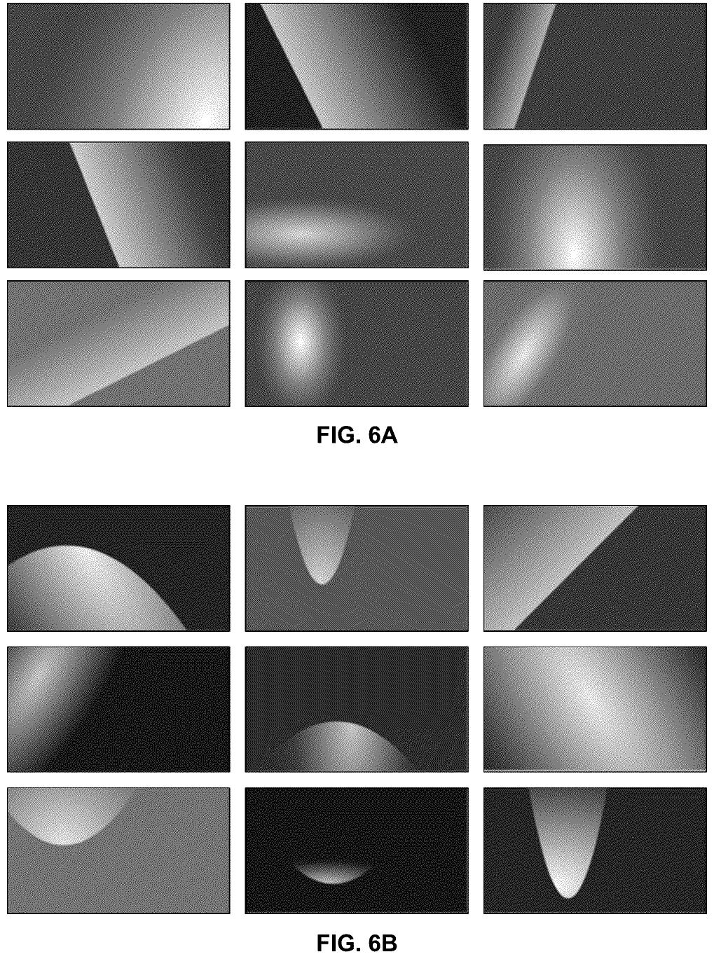

When bright regions are identified in the image rays or lines extending from a center of a bright region to the edge of the image are checked to determine whether the intensity of pixels along such rays or lines varies relatively smoothly along the length of the lines. If the intensity variation is relatively smooth (e.g., satisfies a threshold), this is an indication that the image has a gradient. If the overall intensity of the image is low (e.g., does not satisfy a threshold) or the overall variation of intensity is low (e.g., does not satisfy a threshold) in the image then the image is designated as a non-gradient image because it is unlikely to create any visually disturbing artifacts while display power saving methodologies are applied. FIGS. 6A and 6B below shows examples images used for developing and testing example gradient image detection techniques disclosed herein. FIG. 6A shows programmatically generated images that result in visually noticeable banding artifacts on a display applying display power saving methodology. Thus, the images shown in FIG. 6A are example gradient images. By contrast, FIG. 6B shows images that do not result in visually noticeable banding artifacts on the display when display power saving methodologies are applied. Thus, the images shown in FIG. 6B are example non-gradient images. Both types of images have either a flat or spherical bright region or may be referred to as light source. The intensity range and variation are randomly chosen during image generation to create a diverse dataset. Moreover, this dataset is further manually verified and checked for any visual banding artifacts if the display gamma settings are changed either way and are correctly classified as Gradient or Non-Gradient images.

Following are the high level operations for example gradient detection techniques disclosed herein:

Gradient Image Detection Process
Input: Image
Output: Boolean (Is Gradient or not)

| | |
|---|---|
| Operation 1 | Find bright region(s) in the input image for each channel. |
| | This can be done by image blurring followed by |
| | brightness thresholding. In some examples, the gradient |
| | detection process is only implemented when the brightest |
| | spot in the image satisfies (e.g., exceeds) a threshold |
| | (e.g., at least 150, at least 175, at least 200, or any other |
| | suitable threshold). |
| Operation 2 | Find the center of the bright region and radius of the |
| | region using contours. |
| Operation 3 | If the bright region is circular or oval generate rays or |
| | lines from the center to the sides of the image in all |
| | directions (e.g., at different angles of relatively small |
| | intervals distributed around all 360 degrees). In the |
| | scenario where the bright region is relatively large, |
| | parallel lines associated with each radial line may be |
| | generated. The generated parallel lines are used to |
| | measure and/or detect linear gradients. |
| Operation 4 | Along each line generated during operation 3, the |
| | smoothness of intensity change is statistically measured. |
| | The process of measuring the smoothness of intensity |
| | change is discussed in detail below with regards to the |
| | example smooth line detector circuitry 206. In some |
| | examples, determining smoothness of intensity changes |
| | along the generated lines are comparable to determining |
| | whether a function is differentiable at every point in its |
| | domain. If a smooth change in intensity is detected along |
| | a given line, the line is designated as a smooth line. In |
| | some examples, the range of variation of intensity along |
| | the lines is also measured. If the overall range of |
| | variation (e.g., between highest and lowest intensity |
| | pixels along the line) is relatively low (e.g., less than 100, |
| | less than 75, less than 50, less than 25, or any other |
| | suitable threshold) the line is ignored, even if it turns out |
| | to be smooth. |
| Operation 5 | If the total number of smooth lines found through the |
| | above analysis satisfies (e.g., exceeds a threshold), the |
| | image is designated as a gradient image which can |
| | produce banding artifacts. In some examples, the |
| | threshold number of detected smooth lines to identify an |
| | image as a gradient image is statistically determined. |
| | Details for this process is described below with regards to |
| | the example smooth line detector circuitry 206 and the |
| | example gradient image determination circuitry 208. |

The operations in the gradient image detection process outlined above are described in more detail below with the respective circuitries that performs the associated operations. Operations 1 and 2 are performed by the bright region identifier circuitry 202. Operation 3 is performed by the line generator circuitry 204. Operation 4 is performed by the smooth line detector circuitry 206. Operation 5 is performed by the gradient image determination circuitry 208.

In some examples, the gradient image detector circuitry 106 includes means for determining a gradient. For example, the means for determining a gradient may be implemented by gradient image detector circuitry 106. In some examples, the gradient image detector circuitry 106 may be instantiated by programmable circuitry such as the example programmable circuitry 1212 of FIG. 12. For instance, the gradient image detector circuitry 106 may be instantiated by the example microprocessor 1300 of FIG. 13 executing machine executable instructions such as those implemented by at least blocks 324 of FIG. 3. In some examples, the gradient image detector circuitry 106 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the gradient image detector circuitry 106 may be instantiated by any other combination of hardware, software, and/or firmware. For example, the gradient image detector circuitry 106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the example bright region identifier circuitry 202 identifies a bright region in an image that satisfy a brightness threshold. In some examples, the bright region identifier circuitry 202 is instantiated by programmable circuitry executing bright region identifier instructions and/or configured to perform operations such as those represented by the flowchart of FIG. 3.

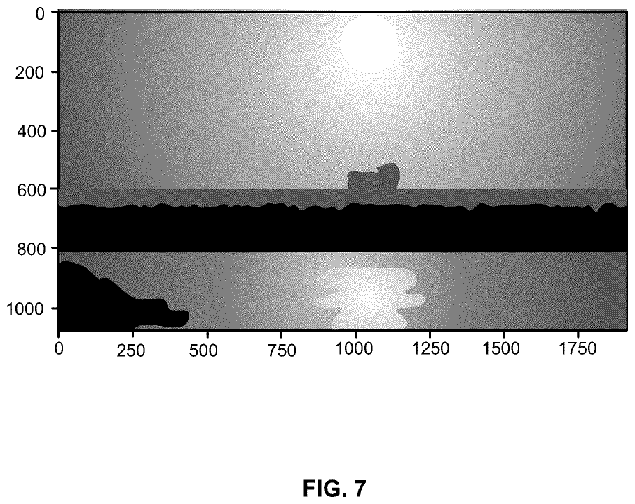

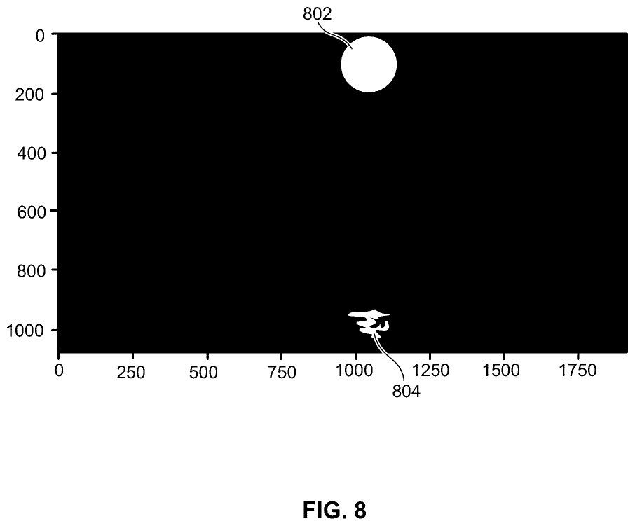

In some examples, the example bright region identifier circuitry 202 identifies a bright region in an image by blurring an input image as represented in example FIG. 7. The example image of FIG. 7 represents a sunset in which the sun is reflected by water of a lake in front of land across the horizon in the background. After the input image is blurred, image thresholding is performed on the blurred image to identify bright region(s) 802, 804 in the image with pixels having an intensity that satisfies (e.g., exceeds) a brightness threshold. That is, in some examples, only those pixels with an intensity satisfying some minimum threshold (e.g., a pixel value of 150 or any other suitable brightness threshold) are identified as bright regions 802, 804 while all other pixels are filtered out. A result of this thresholding operation applied to the example image of FIG. 7 is shown in FIG. 8. Image thresholding segments the blurred image and creates a binary image from the blurred image. In this example, the only regions with pixels having intensities sufficient to satisfy the threshold correspond to the location of the sun in the sky of FIG. 7 and the reflection of the sun in the water. The blurred image can be a grayscale or full-color image.

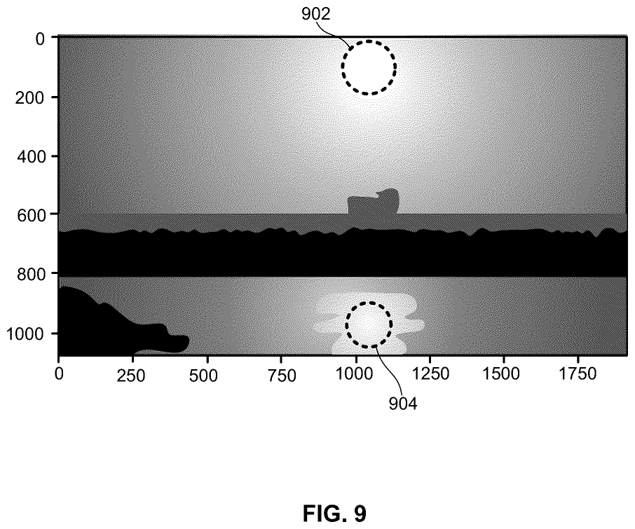

Based on the results of the thresholding operation, the example bright region identifier circuitry 202 determines the location and size of each bright region 802, 804 in the image thresholding output of FIG. 8. In some examples, the bright region identifier circuitry 202 makes this determination by defining circular and/or oval areas or boundaries 902, 904 that surround and/or circumscribe the bright regions 802, 804 using the contours of the bright regions 802, 804 shown in FIG. 8. More particularly, in some examples, the example bright region identifier circuitry 202 defines the location and size of the bright regions by determining the center and the radius (or two radii for an oval) of the circular or oval areas 902. In some examples, the bright region identifier circuitry 202 also defines the orientation or angle of the oval areas 902 (e.g., the angle and/or direction in which the two radii extend). FIG. 9 illustrates the example image of FIG. 7 with a circle boundary 902 identifying the location and size of the bright region 802 corresponding to the sun and an oval boundary 904 identifying the location and size of the bright region 804 of the reflection of the sun in the water. In some examples, the bright region identifier circuitry 202 defines the location and size of a bright region using shapes other than circles and/or ovals. For instance, in some examples, a bright region can be defined by boundaries 902, 904 that have a square and/or rectangular shape (or any other suitable shape) that circumscribes the contours of corresponding bright regions 802, 804 identified by applying the image thresholding.

In some examples, the gradient image detector circuitry 106 includes means for identifying a region in an image that satisfies a brightness threshold (e.g., means for identifying a bright region). For example, the means for identifying may be implemented by the bright region identifier circuitry 202. In some examples, the bright region identifier circuitry 202 may be instantiated by programmable circuitry such as the example programmable circuitry 1212 of FIG. 12. For instance, the bright region identifier circuitry 202 may be instantiated by the example microprocessor 1300 of FIG. 13 executing machine executable instructions such as those implemented by at least blocks 302, 304, 306, 310, 312, 314 and 330 of FIG. 3. In some examples, the bright region identifier circuitry 202 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the bright region identifier circuitry 202 may be instantiated by any other combination of hardware, software, and/or firmware. For example, the bright region identifier circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example line generator circuitry 204 of FIG. 2 generates radial lines that extend outwards from the center of a defined boundary 902, 904 of a bright region 802, 804 to the sides or edges of the image. Additionally or alternatively, the example line generator circuitry 204 generates parallel lines that extend transverse to (e.g., perpendicular to) a long dimension of the defined boundary 902, 904 of a bright region 802, 804. In some examples, the line generator circuitry 204 is instantiated by programmable circuitry executing line generator instructions and/or configured to perform operations such as those represented by the flowchart(s) of FIG. 3.

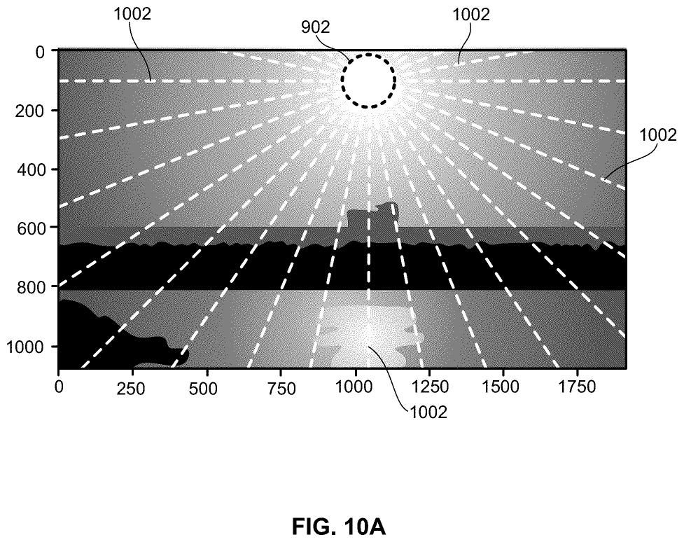

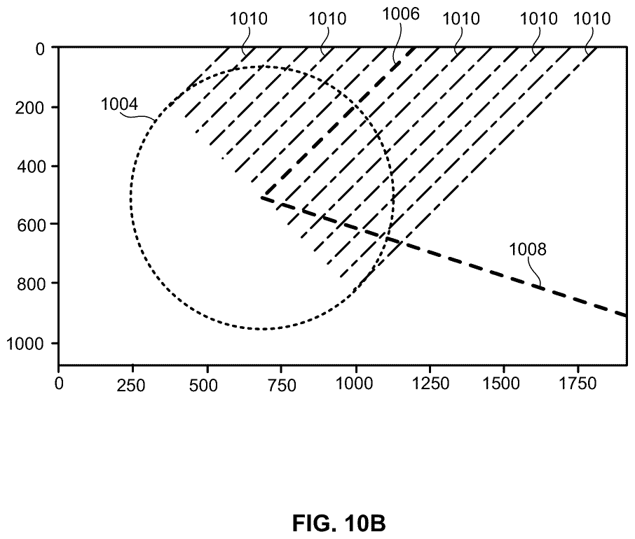

To generate lines, the example line generator circuitry 204 identifies the shape of the bright region 802, 804 and/or, more particularly, the area or boundary 902, 904 determined to circumscribe the bright region 802, 804. Specifically, the example line generator circuitry 204 determines whether the boundary 902, 904 is relatively circular (indicative of the possibility for a radial gradient as shown in the left image in FIG. 5) or is relatively oblong (indicative of the possibility for a linear gradient as shown in the right image in FIG. 5). If the bright region 802, 804 (or associated boundary 902, 904) is relatively circular (e.g., the ratio between a long dimension and a short dimension of the boundary 902, 904 is less than a threshold), the example line generator circuitry 204 generates or draws radial lines or rays extending away from the center of the boundary 902, 904 to the sides or edges of the images in all directions (e.g., at different angles of relatively small intervals distributed around all 360 degrees). Different radial lines 1002 extending outward from the first boundary 902 of FIG. 9 (which is circular) is illustrated in FIG. 10. In this example, 32 separate lines 1002 are shown at angular intervals of 11.25 degrees. However, in other examples, a different number of lines at a different angular interval may be used. In some examples, the number of lines is defined by the number of pixels along the perimeter of the image. That is, a separate line is generated from the center of the boundary 902 to each pixel along the perimeter of the image.

If an identified bright region 802, 804 includes a shape that results in a circular boundary 902, 904 that is relatively large (e.g., a radius of the circular boundary 902, 904 is above a certain threshold length or corresponding threshold number of pixels and/or the area of the circular boundary 902, 904 is above a certain threshold (e.g., is greater than 10% of the image area or any other suitable threshold)), the example line generator circuitry 204 generates or draws additional lines parallel to and on each side of each radial lines as shown in FIG. 10B. Specifically, FIG. 10B illustrates another example image with a circular boundary 1004 that is much larger than the boundaries 902, 904 of FIGS. 9 and 10A. As such, in this example, radial lines are generated as described above in connection with FIG. 10A, with two radial lines 1006, 1008 being shown in FIG. 10B. However, in addition to the radial lines 1006, 1008, multiple other lines 1010 are generated that are parallel to each radial line 1006, 1008. More particularly, in this example, multiple parallel lines 1010 (identified by long and short dashed lines in FIG. 10B) are shown positioned adjacent to the first radial line 1006 (identified by an even broken line in FIG. 10B). As shown in the illustrated example, the parallel lines 1010 are distributed outward from the first radial line 1010 with the outermost parallel line defined by the perimeter of the boundary 1004. That is, in some examples, the distance from the radial line 1004 across which the parallel lines 1010 are distributed is defined by the radius of the circular boundary 1004. In this example, a similar set of parallel lines would be generated for the second radial line 1006 as well as every other radial line emanating from the center of the source (e.g., center of the circular boundary 1002 for the source). In some examples, the spacing of the parallel lines can be any suitable amount proportional to the radius of the circular boundary 1002. In some examples, the spacing is defined by the spacing of pixels in the image. In some examples, both radial lines and parallel lines are generated for a given boundary defining a bright region in an image. These parallel lines 1010 are used to capture linear gradients.

In some examples, the gradient image detector circuitry 106 includes means for defining lines in the image that extend away from the bright region. For example, the means for defining lines may be implemented by line generator circuitry 204. In some examples, the line generator circuitry 204 may be instantiated by programmable circuitry such as the example programmable circuitry 1212 of FIG. 12. For instance, the line generator circuitry 204 may be instantiated by the example microprocessor 1300 of FIG. 13 executing machine executable instructions such as those implemented by at least blocks 316, 317, and 318 of FIG. 3. In some examples, the line generator circuitry 204 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the line generator circuitry 204 may be instantiated by any other combination of hardware, software, and/or firmware. For example, the line generator circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example smooth line detector circuitry 206 analyzes the pixels along the lines 1002 generated by the line generator circuitry 204 to determine whether the lines 1002 are smooth. As used here, a smooth line is a line of pixels in an image along which the change in variation of intensity of the pixels along the lines is relatively consistent (e.g., within a threshold). In some example, the smooth line detector circuitry 206 is instantiated by programmable circuitry executing smooth line detector instructions and/or configured to perform operations such as those represented by the flowchart(s) of FIGS. 3 and 4.

The example smooth line detector circuitry 206 measures smoothness of pixel intensity change along a line as a criteria to determine a smooth line. In some examples, the example smooth line detector circuitry 206 determines the range of variation of intensity along a line. The range of variation of intensity along a line is measured by comparing the highest pixel intensity (e.g., maximum pixel intensity) to the lowest pixel intensity (e.g., minimum pixel intensity) along the line. The range of variation can be determined to be low if the range of variation is less than an intensity variability threshold. For example, if the overall range of variation is relatively low (e.g., less than 100, less than 75, less than 50, less than 25, or any other suitable threshold), the line is ignored, even if it turns out to be smooth. Lines with relatively little variation in intensity, even if the line would qualify as a smooth line, would be ignored because a gradient (if any) associated with such a line is likely to be sufficiently subtle that the human eye is unlikely to see any visual banding. This intensity variability range filter is used to determine if a line is to be considered for smoothness check.

Along each line, if the differences between the maximum pixel intensity and the minimum pixel intensity is more than an intensity variability threshold, the example smooth line detector circuitry 206 determines intensity deltas between pixels in different pairs of pixels along the line. In some examples, an intensity delta is determined for every pair of adjacent pixels along the line. For instance, a first intensity delta is determined between the first and second pixels along the line, a second intensity delta is determined between the second and third pixels along the line, and so on across the line. Thus, in this example, two intensity deltas are determined for any given pixel (except for the end pixels) along the line; one intensity delta is determined with respect to a pixel on one side of a given pixel and the other intensity delta is determined with respect to an adjacent pixel on the other side of the given pixel. In some examples, the pairs of pixels correspond to pixels that are not directly adjacent along the line (e.g., every second pixel, every third pixel, etc.). In some examples, the pairs of pixels overlap with a pixel associated with one pair of pixels being an intermediate pixel between the two pixels in a separate pair of pixels for which an intensity delta is determined. For instance, a first intensity delta is determined between the first and third pixels along the line and a second intensity delta is determined between the second and fourth pixels along the line.

The different intensity deltas between different pixels in different pairs of pixels along a line or ray for a channel (e.g., red, green, and blue (RGB) channel) can be viewed as comparable to a function of a single variable. In mathematics, the function of a single variable is smooth if it is differentiable at every point in its domain. Further, a function is differentiable (and, thus, smooth) at a given point if the slope of a tangent of the function at a point slightly (e.g., infinitesimally) to the left of the point is equal the tangent of the function at a point slightly (e.g., infinitesimally) to the right of the point. The same general analysis is used to determine the smoothness of the change in intensity along a line as disclosed herein, with each intensity delta associated with a different pair of pixels corresponding to the relatively small amount of shift in points along the single variable function. However, unlike continuous mathematical functions, for which infinitesimal differences can be analyzed, the intensity values for pixels along a given line are necessarily discrete. As such, unlike a mathematical function for which smoothness is determined based on the slopes at different infinitesimal shifted points of a function being equal, a line in an image of examples disclosed herein (e.g., one of the lines 1002 in FIG. 10) is determined to be smooth at a given point (e.g., at a given pixel) when the intensity deltas of different pairs of pixels associated with the given point (e.g., on either side of the given pixel) are nearly the same (e.g., a difference between the intensity deltas is less than a threshold).

Thus, in some examples, after determining the intensity deltas for different pairs of pixels, the example smooth line detector circuitry 206 calculates differences between the intensity deltas associated with proximate (e.g., adjacent) ones of the pairs of pixels along the line. In some examples, the example smooth line detector circuitry 206 then compares the intensity differences to a threshold difference. When the intensity differences are less than the threshold, this is an indication that the change in intensity along the line at this point is relatively small, which is an indication that the line is smooth and potentially indicative of a gradient. The amount of change in intensity deltas between adjacent pairs of pixels along a line of a gradient is dependent on the overall range of intensity variability across the gradient along the line, as well as the number of pixels across which the gradient extends. That is, a line may correspond to a smooth gradient with each incremental change between adjacent pixels being relatively small when the gradient is associated with a relatively large number of pixels along the line and the variability of intensity across the gradient is relatively small (e.g., the intensity in the gradient changes relatively slowing along a relatively long distance across the image). By contrasts, a line may correspond to a smooth gradient with each incremental change between adjacent pixels being relatively large when the gradient extends is associated with a relatively short number of pixels along the line and the variability of intensity across the gradient is relatively large (e.g., the intensity in the gradient changes relatively quickly along a relatively short distance across the image). In some examples, the difference threshold is selected to cover these different possible scenarios. Specifically, testing on several gradient and non-gradient images has shown that an example threshold difference value can be 20. However, any other suitable threshold difference may be used (e.g., a threshold of 5, 10, 15, 25, 30, etc.). This infinity norm filter acts as a simple filter for smooth lines.

Using a threshold difference value of 20 there is still a possibility that the example gradient image detector circuitry 106 produces false positives or false detections of smooth lines. More particularly, the mere fact that there is a small change (e.g., less than the threshold value of 20) between intensity deltas of adjacent pairs of pixels at one point on a line is not itself an indication of a gradient. Rather, a gradient involves relatively smooth changes over some distance. As such, for a gradient to be detected along a line, there needs to be relatively small change between other pairs of pixels at other points along a given line in an image (e.g., associated with the full length of the gradient along the line). Accordingly, to further facilitate the identification of smooth lines in images that are indicative of gradients, the example smooth line detector circuitry 206 determines if there are a threshold number of adjacent pairs of pixels where the differences of intensity deltas for each pair of pixels is less than the threshold difference. If there are a threshold number of pairs, then the example smooth line detector circuitry 206 determines that the line is smooth. If the number of pairs does not satisfy the threshold number, then the example smooth line detector circuitry 206 determines the line is not smooth. The measure of the threshold number of adjacent pairs is a robust measure and avoids outliers. In some examples, the value for the threshold number is set as a percentage of the total number of pixels along a line (rather than with an absolute number of pixels) because lines can differ significantly in length depending on the location of the bright region 802, 804 defining the beginning point of the lines 1002 and what direction a given line extends from the bright region 802, 804. In some examples, an example 75% (or any other suitable percentile) of adjacent pairs of pixels along the lines has to be less than the threshold difference for a line to be designated as a smooth line.

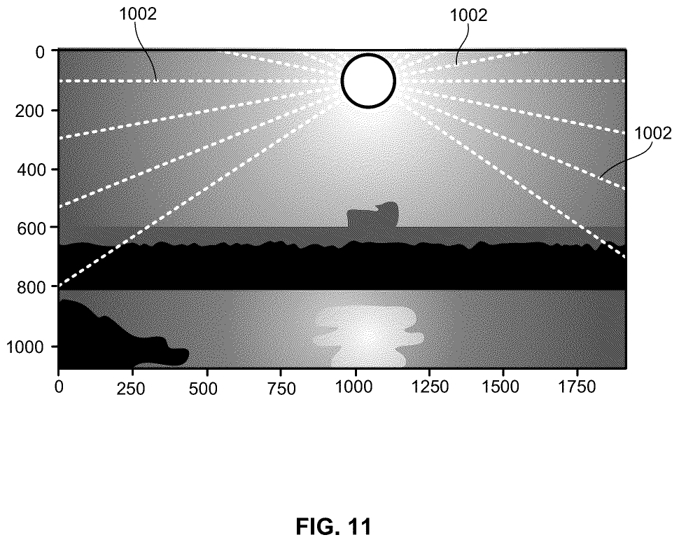

In some examples, after determining whether one given line 1002 in an image is smooth, the example smooth line detector circuitry 206 can repeat the determination process for every other line generated by the line generator circuitry 204. In some examples, the example smooth line detector circuitry 206 can perform the determination of smoothness of multiple (e.g., all) rays or lines 1002 in parallel. In many cases, not all lines 1002 analyzed by the smooth line detector circuitry 206 will be designated as smooth lines because the lines will fail to pass through one or more of the filters sets forth above. For instance, FIG. 11 shows the image of FIG. 7 with the lines 1002 of FIG. 10 determined to be smooth lines in this examples.

As described above, the illustrated example uses three criteria for smoothness detection including variability range filter, the infinity norm filter, and the percentile computation. Each of these criteria has different computational complexity. A time complexity can be used to describe the computational complexity, the time complexity refers to the amount of time it takes to run each of these filters. The time complexity is estimated by counting the length of line or number of points (e.g., pixels) on the line (N) performed by the filter, supposing that each point takes a fixed amount of time to perform. The simplest and most computationally cost efficient criteria is the intensity variability range filter which can be done with a time complexity of order O(N). The O(N) time complexity is a linear time algorithm, this means that the running time increases at most linearly with the number of the points (N) on the line. The infinity norm filter is moderately complex. This is still linear but involves derivative computations (e.g., 3N computations). The most complex filter, requires sorting for percentile computation and involves time complexity of order O(N log₂ [symbol] N) [symbol] but can be further improved (e.g., optimised) by using a bucket sort type process. The O(N log₂ [symbol] N) [symbol] time complexity is a quasilinear time (also referred to as log-linear time), the running time for this process is the result of performing a (log N) operation N times. Below, is an example process (Process 2) for smooth line detection:

Process 2: Smooth Line Detection Process

```
Input: A line L( list of pixels (x, y) on the line in image), Image I
(gray or single Channel)
Output: Score (≥ 0) for smoothness (0 indicates very smooth)
Intensities ← Look up pixel values of image I along the given
line L
If Max(Intensities) − Min(Intensities) > 50
  FirstPixel ← First order difference series of Intensities
  SecondPixel ← First order difference series of Negated or
  −Intensities / −1
  If ∥FirstPixel − SecondPixel ∥_∞ <
  ThresholdDifference, Θ
    sortedDifferences = Sort(FirstPixel − SecondPixel)
    P = 75 th Percentile in sortedDifferences
    Return P
Return Infinity
```

In some examples, the gradient image detector circuitry 106 includes means for determining a line is smooth, which includes means for determining an intensity variability along a line, means for determining an intensity delta between two (e.g., a pair of) pixels along a line and means for comparing the differences of intensity deltas (for different pairs of pixels) to a threshold difference. For example, the means for determining intensity may be implemented by the smooth line detector circuitry 206. In some examples, the smooth line detector circuitry 206 may be instantiated by programmable circuitry such as the example programmable circuitry 1212 of FIG. 12. For instance, the smooth line detector circuitry 206 may be instantiated by the example microprocessor 1300 of FIG. 13 executing machine executable instructions such as those implemented by at least blocks 320 of FIGS. 3, 402, 404, 406, 408, 410, 412, 414 and 416 of FIG. 4. In some examples, the smooth line detector circuitry 206 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the smooth line detector circuitry 206 may be instantiated by any other combination of hardware, software, and/or firmware. For example, the smooth line detector circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example gradient image determination circuitry 208 determines the smooth lines detected by the smooth line detector circuitry 206 indicates the presence of a gradient image that leads to banding artifacts. In some examples, the gradient image determination circuitry 208 is instantiated by programmable circuitry executing gradient image determination instructions and/or configured to perform operations such as those represented by the flowchart(s) of FIG. 3.

As a gradient can be in any direction, the rays, or lines 1002 show in FIG. 10 are drawn emanating radially outward from the center of the bright region 802 (demarcated by the circle 902) to the sides or edges of the images (e.g., at different angles of relatively small intervals distributed around all 360 degrees). There is a possibility that not all of these lines will be smooth but, if the image includes a gradient, at least a few of the lines may be identified as smooth lines. However, the presence of a few smooth lines may not create any visual artifacts (e.g., banding effects) if display power saving methodologies (e.g., contrast enhancement) are employed. In the illustrated examples, the example gradient image determination circuitry 208 determines whether there are a sufficient number of smooth lines (e.g., the number satisfies (e.g., exceeds) a threshold) to lead noticeable banding artifacts. In some examples, the threshold is statistically determined by evaluating smooth lines on various gradient and non-gradient images (such as those shown in FIGS. 6A and 6B). The threshold may depend on the granularity with which the lines were analyzed including the angular interval of adjacent ones of the lines, as well as the spacing of the pixels defining the pairs of pixels used to determine the intensity deltas within each given line. An example value for the threshold number of smooth lines that indicates a relatively high likelihood of a gradient image that may give rise to visual artifacts is 100 lines. However, other threshold numbers of smooth lines higher or lower than 100 may also be used (e.g., at least 25 lines, at least 50 lines, at least 75 lines, at least 150 lines, at least 200 lines, etc.).

In identifying the gradient image, performance metrics such as precision and recall are applied to data retrieved from a collection of test images (e.g., the images of FIGS. 6A and 6B). Precision is a performance metric that applies to data retrieved from a collection. Precision, also called positive predictive value, is the fraction of relevant instances among the retrieved instances. Recall is a performance metric that applies to data retrieved from a collection of sample. Recall, also known as sensitivity, is the fraction of relevant instances that were retrieved. False positive rate (FPR) is the amount of false detections made versus the recall percentage. At a FPR of 17%, experimental testing of an example implementation of the example gradient image detector circuitry 106 of FIG. 2 achieved a 94% precision for a banding class as shown in the table below.

| | precision | recall | f1-score | support |
|---|---|---|---|---|
| banding | 0.94 | 0.76 | 0.84 | 832 |
| nonbanding | 0.47 | 0.83 | 0.60 | 214 |
| accuracy | | | 0.77 | 1046 |
| macro avg | 0.71 | 0.79 | 0.72 | 1046 |
| weighted avg | 0.85 | 0.77 | 0.79 | 1046 |

Although experimental testing of the example techniques disclosed herein produced about 17% false positives, this is not a major problem. The false positives will have little to no impact on processing capacity. Further, while the false positives can result in an improper disablement of display power saving methodologies, such that there is no power saving, the image quality will avoid banding effects to improve user experience. As a result, a user is more likely to use the display power saving methodologies the rest of the time rather than disable the feature entirely due to the instances when gradient images occur and create banding effects that are not otherwise avoided based on the implementation of teachings disclosed herein. That is, rather than the false positives being a problem, false negatives have a much greater chance of producing bad user experience that may lead to greater losses in potential power savings based on the user completely disabling display power saving methodologies. The recall of gradient detection is relatively high at 76% and also has a very good precision at 92%. In short, most gradient images are captured accurately using teachings disclosed herien to provide good user experience when the display power saving methodologies are enabled.

In some examples, the gradient image detector circuitry 106 includes means for determining a region corresponds to a gradient which includes means for determining a threshold number of lines are smooth, and/or means for determining an image includes a gradient. For example, the means for determining may be implemented by gradient image determination circuitry 208. In some examples, the gradient image determination circuitry 208 may be instantiated by programmable circuitry such as the example programmable circuitry 1212 of FIG. 12. For instance, the gradient image determination circuitry 208 may be instantiated by the example microprocessor 1300 of FIG. 13 executing machine executable instructions such as those implemented by at least blocks 322, 324, and 328 of FIG. 3. In some examples, the gradient image determination circuitry 208 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the gradient image determination circuitry 208 may be instantiated by any other combination of hardware, software, and/or firmware. For example, the gradient image determination circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the gradient image detector circuitry 106 of FIG. 1 is illustrated in FIG. 2, one or more of the elements, processes, and/or devices illustrated in FIG. 2 may be combined, divided, re-arranged, omitted, eliminated, and/or implemented in any other way. Further, the example bright region identifier circuitry 202, the example line generator circuitry 204, the example smooth line detector circuitry 206, the example gradient image determination circuitry 208, and/or, more generally, the example gradient image detector circuitry 106 of FIG. 2, may be implemented by hardware alone or by hardware in combination with software and/or firmware. Thus, for example, any of the example bright region identifier circuitry 202, the example line generator circuitry 204, the example smooth line detector circuitry 206, the example gradient image determination circuitry 208, and/or, more generally, the example gradient image detector circuitry 106, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example gradient image detector circuitry 106 of FIG. 2 may include one or more elements, processes, and/or devices in addition to, or instead of, those illustrated in FIG. 2, and/or may include more than one of any or all of the illustrated elements, processes, and devices.

Flowchart(s) representative of example machine readable instructions, which may be executed by programmable circuitry to implement and/or instantiate the gradient image detector circuitry 106 of FIG. 2 and/or representative of example operations which may be performed by programmable circuitry to implement and/or instantiate the gradient image detector circuitry 106 of FIG. 2, are shown in FIGS. 3, and 4. The machine readable instructions may be one or more executable programs or portion(s) of one or more executable programs for execution by programmable circuitry such as the programmable circuitry 1212 shown in the example processor platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3, and 4, many other methods of implementing the example gradient image detector circuitry 106 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3, and 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to implement the display controller circuitry 104 of FIG. 1 to detect a gradient image and improve display power savings. The example machine-readable instructions and/or the example operations 300 of FIG. 3 begin at block 302, at which the bright region identifier circuitry 202 (FIG. 2) blurs an input image. As discussed above, FIG. 7 illustrates an example blurred image. After the image is blurred, the example bright region identifier circuitry 202 implements image thresholding (block 304). FIG. 8 illustrates the output of the image thresholding applied to the example blurred image of FIG. 7. The example bright region identifier circuitry 202 determines whether the intensity of a brightest spot in an image is more than a brightness threshold (block 310). In some examples, the brightness threshold is the same threshold used for the image thresholding at block 304. Thus, in some examples, the determination at block 310 is the same as determining whether there is at least one bright region (e.g., the bright regions 802, 804 of FIG. 8) in the output image thresholding operation. If the intensity of the brightest spot is less than a brightness threshold (e.g., there is no bright region) (block 310: NO), no bright region is identified in the image (block 306). In this situation, the example display power saving circuitry 108 (FIG. 1) applies contrast enhancement to the image (block 308) and the example instructions and/or operations of FIG. 3 end.

Returning to block 310, if the intensity of the brightest spot in the image is more than a brightness threshold (e.g., there is a at least one bright region) (block 310: YES), the example bright region identifier circuitry 202 identifies a location and size of a bright region using contours of the bright regions (block 312). FIG. 9 illustrates examples circular areas 902, 904 demarcating the size and location of the bright regions 802, 804 shown in FIG. 8. Control proceeds to block 314 at which the example bright region identifier circuitry 202 determines whether the size of the boundary of the bright region satisfies (e.g., exceeds) a threshold. If the size does not exceed a threshold (block 314: NO), the bright region is determined to be relatively small such that a linear gradient is unlikely. Accordingly, in such situations, the example line generator circuitry 204 (FIG. 2) generates or draws radial lines or rays extending away from the center of the bright region to sides or edges of the image (block 316). If the size exceeds a threshold (block 314: YES), the bright region is determined to be relatively large, thereby potentially indicating a linear gradient. In such situations, the example line generator circuitry 204 generates or draws radial lines or rays extending away from the center of the bright region to sides or edges of the image (block 317). Thereafter, the example line generator circuitry 204 generates or draws a set of parallel lines for each radial lines (block 318).

The example smooth line detector circuitry 206 (FIG. 2) detects whether any of the lines are smooth (block 320), as described below in connection with FIG. 4. Control proceeds to block 322 at which the example gradient image determination circuitry 208 (FIG. 2) determines whether a threshold number of smooth lines is detected. If a threshold number of smooth lines is detected (block 322: YES), then the example gradient image determination circuitry 208 determines the image is a gradient image (e.g., includes a gradient image likely to producing banding artifacts) (block 324). The example display power saving circuitry 108 does not apply contrast enhancement to the image (block 326). That is, in such situations, the example display power saving circuitry 108 inhibits and/or temporarily disables the contrast enhancement. Thereafter, the example instructions and/or operations of FIG. 3 end.

Returning to block 322, if a threshold number of smooth lines is not detected (block 322: NO), the example gradient image determination circuitry 208 determines the image is not a gradient image (block 328). Control proceeds to block 330 at which the example bright region identifier circuitry 202 determines whether another bright region exist on the image. If another bright region is identified (block 330: YES), control returns to block 312 to repeat the process as described above. If no other bright region is identified in the image (block 330: NO), the example display power saving circuitry 108 applies contrast enhancement to the image (block 332), and the example instructions and/or operations of FIG. 3 end.

FIG. 4 is a flowchart representative of example machine readable instructions and/or example operations 400 that may be executed, instantiated, and/or performed by programmable circuitry to implement the smooth line detector circuitry 206 of FIG. 2 to determine whether lines in an image (e.g., as generated at block 316, block 317, and/or block 318 of FIG. 3) are smooth. The example machine-readable instructions and/or the example operations 400 of FIG. 4 begin at block 402, at which the example smooth line detector circuitry 206 (FIG. 2) determines whether the difference between the maximum pixel intensity and the minimum pixel intensity along a line is greater than an intensity variability threshold. If the difference between the maximum pixel intensity and the minimum pixel intensity along the line is not greater than an intensity variability threshold (block 402: NO), the line is not smooth (block 404), and control advances to block 416.

If the difference between the maximum pixel intensity and the minimum pixel intensity along the line is greater than an intensity variability threshold (block 402: YES), the example smooth line detector circuitry 206 determines different intensity deltas between pixels in different pairs of pixels along the line (block 406). Thereafter, the example smooth line detector circuitry 206 determines the difference in the intensity deltas corresponding to adjacent ones of the different pairs of pixels along the line (block 408). Then, the example smooth line detector circuitry 206 compares the differences of the intensity deltas to a threshold difference (block 410). Control proceeds to block 412 at which the example smooth line detector circuitry 206 determines whether there are threshold number of adjacent pairs where the differences of intensity deltas are less than the threshold difference. If there is not at least a threshold number of adjacent pairs where the differences of intensity deltas is less than the threshold difference (block 412: NO), the example smooth line detector circuitry 206 determines that the line is not smooth (block 404), and control again proceeds to block 416. If there is at least a threshold number of adjacent pairs of pixels where the differences of intensity deltas is less than the threshold difference (block 412: YES), the example smooth line detector circuitry 206 determines that the line is smooth (block 414). Thereafter, control advances to block 416 where the example smooth line detector circuitry 206 determines whether there is another line to analyze. If so, control returns to block 402 to repeat the process for another line. Otherwise, the example instructions and/or operations 400 returns to block 322 of FIG. 3.

While the flowcharts of FIGS. 3 and 4 are described in the context of controlling when a display power saving methodology is to be applied (e.g., the contrast enhancement applied at block 308 and 332 and inhibited at block 326), teachings disclosed herein can be used in other situations. For instance, instead of using examples disclosed herein to detect images in a display pipeline, examples can be used to classify and/or label images within a database as either gradient images or non-gradient images. Classifying or labelling such images can facilitate the automatic creation of training images for a machine learning (e.g., an artificial intelligence (AI)) model to detect such images using a low power AI accelerator inside a TCON.

FIG. 12 is a block diagram of an example programmable circuitry platform 1200 structured to execute and/or instantiate the example machine-readable instructions and/or the example operations of FIGS. 3, and 4 to implement the gradient image detector circuitry 106 of FIG. 2. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, and/or microcontrollers from any desired family or manufacturer. The programmable circuitry 1212 may be implemented by one or more semiconductor based (e.g., silicon based) devices. In this example, the programmable circuitry 1212 implements the example bright region identifier circuitry 202, the example line generator circuitry 204, the example smooth line detector circuitry 206, the example gradient image determination circuitry 208, and/or, more generally, the example gradient image detector circuitry 106. The programmable circuitry 1212 also implements the example display power saving circuitry 108.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1232, which may be implemented by the machine readable instructions of FIGS. 3, and 4, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 3, and 4 to effectively instantiate the circuitry of FIG. 2 as logic circuits to perform operations corresponding to those machine readable instructions. In some such examples, the circuitry of FIG. 2 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 3, and 4.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic, and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowchart(s) of FIGS. 3, and 4 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3, and 4. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3, and 4. As such, the FPGA circuitry 1400 may be configured and/or structured to effectively instantiate some or all of the operations/functions corresponding to the machine readable instructions of the flowchart(s) of FIGS. 3, and 4 as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIGS. 3, and 4 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable, or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIGS. 3, and 4 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine readable instructions represented by the flowchart(s) of FIGS. 3, and 4 to perform first operation(s)/function(s), the FPGA circuitry 1400 of FIG. 14 may be configured and/or structured to perform second operation(s)/function(s) corresponding to a second portion of the machine readable instructions represented by the flowcharts of FIGS. 3, and 4, and/or an ASIC may be configured and/or structured to perform third operation(s)/function(s) corresponding to a third portion of the machine readable instructions represented by the flowcharts of FIGS. 3, and 4.

It should be understood that some or all of the circuitry of FIG. 2 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIG. 2 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

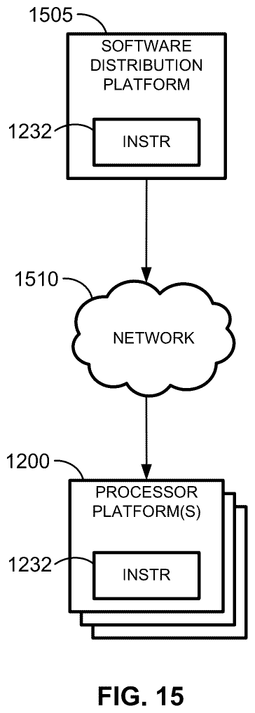

A block diagram illustrating an example software distribution platform 1505 to distribute software such as the example machine readable instructions 1232 of FIG. 12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions of FIGS. 3, and 4, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions of FIGS. 3, and 4, may be downloaded to the example programmable circuitry platform 1200, which is to execute the machine readable instructions 1232 to implement the gradient image detector circuitry 106. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “substantially”, “approximately” and “about” modify their subjects/values to recognize the potential presence of variations that occur in real world applications. For example, “substantially”, “approximately” and “about” may modify dimensions that may not be exact due to manufacturing tolerances and/or other real world imperfections as will be understood by persons of ordinary skill in the art. For example, “substantially”, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable the detection of gradient images rendered on a display. The ability to automatically detect such images enables the ability to adjust display power saving methodologies in a manner that maintains relatively high user experience while also reducing or saving power consumption. Disclosed systems, apparatus, articles of manufacture, and methods improve the efficiency of using a computing device by implementing gradient image detector circuitry that enables detection of gradient images rendered on a display and adjustments to display power to save power consumption. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to enable the detection of gradient images rendered on a display to adjust display power saving methodologies in a manner that maintains relatively high user experience while also reducing or saving power consumption are disclosed herein. Further examples and combinations thereof include the following: Example 1 includes an apparatus comprising interface circuitry, machine readable instructions, and programmable circuitry to at least one of instantiate or execute the machine readable instructions to identify a region in an image that satisfies a brightness threshold, define a plurality of lines in the image that extend away from the region, and determine the region corresponds to a gradient based on an analysis of pixels along different ones of the plurality of lines.

Example 2 includes the apparatus of example 1, wherein the region is circular or oval, and the plurality of lines extend away from a center of the region and extend to sides of the image.

Example 3 includes the apparatus of example 1, wherein the plurality of lines includes (a) a plurality of radial lines extending away from a center of the region and (b) multiple sets of parallel lines, lines in different ones of the sets of parallel lines to be parallel to different ones of the radial lines.

Example 4 includes the apparatus of example 1, wherein the analysis of pixels along the plurality of lines corresponds to an analysis of a smoothness of change in intensity of the pixels along the different ones of the plurality of lines.

Example 5 includes the apparatus of example 4, wherein the analysis of the smoothness of change in the intensity of the pixels along a first line of the plurality of lines includes determining different intensity deltas between pixels in different pairs of pixels along the first line, determining differences between the different intensity deltas associated with adjacent ones of the pairs of pixels, and comparing the differences to a threshold difference.

Example 6 includes the apparatus of example 5, wherein the programmable circuitry is to determine the first line is smooth when a threshold number of the differences are less than or equal to the threshold difference.

Example 7 includes the apparatus of example 6, wherein the programmable circuitry is to determine the region corresponds to the gradient when a threshold number of the plurality of lines are determined to be smooth.

Example 8 includes the apparatus of example 4, wherein the programmable circuitry is to determine an intensity variability for a first line of the plurality of lines, the intensity variability corresponding to a difference between a maximum pixel intensity and a minimum pixel intensity along the first line, and exclude the first line from the analysis of the smoothness of change in the intensity of the pixels along the different ones of the plurality of lines when the intensity variability is less than an intensity variability threshold.

Example 9 includes the apparatus of example 1, where the programmable circuitry is to adjust a contrast of successive ones of a series of frames to be presented on a display to reduce power consumption of the display, and stop the adjustment to the contrast of the series of frames for ones of the frames that include the image.

Example 10 includes a non-transitory machine readable storage medium comprising instructions to cause programmable circuitry to at least identify a region in an image that satisfies a brightness threshold, define a plurality of lines in the image that extend away from the region, and determine the region corresponds to a gradient based on an analysis of pixels along different ones of the plurality of lines.

Example 11 includes the non-transitory machine readable storage medium of example 10, wherein the region is circular or oval, and the plurality of lines extend away from a center of the region and extend to sides of the image.

Example 12 includes the non-transitory machine readable storage medium of example 10, wherein the region has a first dimension, and a second dimension perpendicular to the first dimension, a ratio between the first dimension and the second dimension exceeds a threshold, and different ones of the plurality of lines to be parallel to one another and transverse to the first dimension of the region when the ratio between the first dimension and the second dimension exceeds the threshold.

Example 13 includes the non-transitory machine readable storage medium of example 10, wherein the analysis of pixels along the plurality of lines corresponds to an analysis of a smoothness of change in intensity of the pixels along the different ones of the plurality of lines.

Example 14 includes the non-transitory machine readable storage medium of example 13, wherein the analysis of the smoothness of change in the intensity of the pixels along a first line of the plurality of lines includes determining different intensity deltas between pixels in different pairs of pixels along the first line, determining differences between the different intensity deltas associated with adjacent ones of the pairs of pixels; and comparing the differences to a threshold difference.

Example 15 includes the non-transitory machine readable storage medium of example 14, wherein the instructions is to cause the programmable circuitry to determine the first line is smooth when a threshold number of the differences are less than or equal to the threshold difference.

Example 16 includes the non-transitory machine readable storage medium of example 15, wherein the instructions is to cause the programmable circuitry to determine the region corresponds to the gradient when a threshold number of the plurality of lines are determined to be smooth.

Example 17 includes the non-transitory machine readable storage medium of example 13, wherein the instructions is to cause the programmable circuitry to determine an intensity variability for a first line of the plurality of lines, the intensity variability corresponding to a difference between a maximum pixel intensity and a minimum pixel intensity along the first line, exclude the first line from the analysis of the smoothness of change in the intensity of the pixels along the different ones of the plurality of lines when the intensity variability is less than an intensity variability threshold.

Example 18 includes the non-transitory machine readable storage medium of example 10, wherein the instructions is to cause the programmable circuitry to adjust a contrast of successive ones of a series of frames to be presented on a display to reduce power consumption of the display and stop the adjustment to the contrast of the series of frames for ones of the frames that include the image.

Example 19 includes a method comprising identifying a region in an image that satisfies a brightness threshold, defining a plurality of lines in the image that extend away from the region, and determining the region corresponds to a gradient based on an analysis of pixels along different ones of the plurality of lines.

Example 20 includes the method of example 19, wherein the region is circular or oval, and the plurality of lines extend away from a center of the region and extend to sides of the image.

Example 21 includes the method of example 19, wherein the region has a first dimension, and a second dimension perpendicular to the first dimension, a ratio between the first dimension and the second dimension exceeds a threshold, and different ones of the plurality of lines to be parallel to one another and transverse to the first dimension of the region when the ratio between the first dimension and the second dimension exceeds the threshold.

Example 22 includes the method of example 19, wherein the analysis of pixels along the plurality of lines corresponds to an analysis of a smoothness of change in intensity of the pixels along the different ones of the plurality of lines.

Example 23 includes the method of example 22, wherein the analysis of the smoothness of change in the intensity of the pixels along a first line of the plurality of lines includes determining different intensity deltas between pixels in different pairs of pixels along the first line, determining differences between the different intensity deltas associated with adjacent ones of the pairs of pixels; and comparing the differences to a threshold difference.

Example 24 includes the method of example 23, further including determining the first line is smooth when a threshold number of the differences are less than or equal to the threshold difference.

Example 25 includes the method of example 24, wherein further including determining the region corresponds to the gradient when a threshold number of the plurality of lines are determined to be smooth.

Example 26 includes the method of example 22, further including determining an intensity variability for a first line of the plurality of lines, the intensity variability corresponding to a difference between a maximum pixel intensity and a minimum pixel intensity along the first line, and excluding the first line from the analysis of the smoothness of change in the intensity of the pixels along the different ones of the plurality of lines when the intensity variability is less than an intensity variability threshold.

Example 27 includes the method of example 19, further including adjusting a contrast of successive ones of a series of frames to be presented on a display to reduce power consumption of the display, and stopping the adjustment to the contrast of the series of frames for ones of the frames that include the image.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
identify a region in an image that satisfies a brightness threshold;
define a plurality of lines in the image that extend away from the region; and
determine the region corresponds to a gradient based on an analysis of pixels along different ones of the plurality of lines.

2. The apparatus of claim 1, wherein the region is circular or oval, and the plurality of lines extend away from a center of the region and extend to sides of the image.

3. The apparatus of claim 1, wherein the plurality of lines includes (a) a plurality of radial lines extending away from a center of the region and (b) multiple sets of parallel lines, lines in different ones of the sets of parallel lines to be parallel to different ones of the radial lines.

4. The apparatus of claim 1, wherein the analysis of pixels along the plurality of lines corresponds to an analysis of a smoothness of change in intensity of the pixels along the different ones of the plurality of lines.

5. The apparatus of claim 4, wherein the analysis of the smoothness of change in the intensity of the pixels along a first line of the plurality of lines includes:
determining different intensity deltas between pixels in different pairs of pixels along the first line;
determining differences between the different intensity deltas associated with adjacent ones of the pairs of pixels; and
comparing the differences to a threshold difference.

6. The apparatus of claim 5, wherein the programmable circuitry is to determine the first line is smooth when a threshold number of the differences are less than or equal to the threshold difference.

7. The apparatus of claim 6, wherein the programmable circuitry is to determine the region corresponds to the gradient when a threshold number of the plurality of lines are determined to be smooth.

8. The apparatus of claim 4, wherein the programmable circuitry is to:
determine an intensity variability for a first line of the plurality of lines, the intensity variability corresponding to a difference between a maximum pixel intensity and a minimum pixel intensity along the first line; and
exclude the first line from the analysis of the smoothness of change in the intensity of the pixels along the different ones of the plurality of lines when the intensity variability is less than an intensity variability threshold.

9. The apparatus of claim 1, where the programmable circuitry is to:
adjust a contrast of successive ones of a series of frames to be presented on a display to reduce power consumption of the display; and
stop the adjustment to the contrast of the series of frames for ones of the frames that include the image.

10. A non-transitory machine readable storage medium comprising instructions to cause programmable circuitry to at least:
identify a region in an image that satisfies a brightness threshold;
define a plurality of lines in the image that extend away from the region; and
determine the region corresponds to a gradient based on an analysis of pixels along different ones of the plurality of lines.

11. The non-transitory machine readable storage medium of claim 10, wherein the analysis of pixels along the plurality of lines corresponds to an analysis of a smoothness of change in intensity of the pixels along the different ones of the plurality of lines.

12. The non-transitory machine readable storage medium of claim 11, wherein the analysis of the smoothness of change in the intensity of the pixels along a first line of the plurality of lines includes:
determining different intensity deltas between pixels in different pairs of pixels along the first line;
determining differences between the different intensity deltas associated with adjacent ones of the pairs of pixels; and
comparing the differences to a threshold difference.

13. The non-transitory machine readable storage medium of claim 12, wherein the instructions is to cause the programmable circuitry to determine the first line is smooth when a threshold number of the differences are less than or equal to the threshold difference.

14. The non-transitory machine readable storage medium of claim 13, wherein the instructions is to cause the programmable circuitry to determine the region corresponds to the gradient when a threshold number of the plurality of lines are determined to be smooth.

15. The non-transitory machine readable storage medium of claim 10, wherein the instructions is to cause the programmable circuitry to:
adjust a contrast of successive ones of a series of frames to be presented on a display to reduce power consumption of the display; and
stop the adjustment to the contrast of the series of frames for ones of the frames that include the image.

16. A method comprising:
identifying a region in an image that satisfies a brightness threshold;
defining a plurality of lines in the image that extend away from the region; and
determining the region corresponds to a gradient based on an analysis of pixels along different ones of the plurality of lines.

17. The method of claim 16, further including determining a first line is smooth when a threshold number of intensity deltas associated with adjacent pairs of pixels are less than or equal to a threshold difference.

18. The method of claim 17, wherein further including determining the region corresponds to the gradient when a threshold number of the plurality of lines are determined to be smooth.

19. The method of claim 16, further including:
determining an intensity variability for a first line of the plurality of lines, the intensity variability corresponding to a difference between a maximum pixel intensity and a minimum pixel intensity along the first line; and
excluding the first line from the analysis of a smoothness of change in the intensity of the pixels along the different ones of the plurality of lines when the intensity variability is less than an intensity variability threshold.

20. The method of claim 16, further including:
adjusting a contrast of successive ones of a series of frames to be presented on a display to reduce power consumption of the display; and
stopping the adjustment to the contrast of the series of frames for ones of the frames that include the image.
